(19) United States
(12) Patent Application Publication
(10) Pub. No.: US 2002/0161615 A1
(43) Pub. Date: Oct. 31, 2002

(54) Workflow system

(76) Inventors: Hitoshi Yui, Yokohama (JP); Atsushi Nakamura, Yokohama (JP); Yutaka Yoshida, Osaka (JP); Syuji Fujimoto, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/128,284

(22) Filed: Apr. 24, 2002

(30) Foreign Application Priority Data
Apr. 26, 2001 (JP) 2001-128612

(51) Int. Cl. G06F 17/60

(52) U.S. Cl. 705/7

(57) ABSTRACT

A workflow system for causing an external business system to execute a part of works, includes a unit for defining the external business system as one of the works, a unit for obtaining the status of the work being executed in the external business system, a unit for defining a process for suspending the work being executed in the external business system, and a unit for instructing the external business system to suspend the work being executed in the external business system. The unit for defining the process of suspension defines whether suspension can be performed, the suspension process, and a recovery process in accordance with the status of the work being executed in the external business system.

### BACKGROUND OF THE INVENTION

The present invention relates to a workflow system. More specifically, the invention relates to a system that includes an external business system as a part of a workflow.

Workflow systems have a function of defining business consisting of a sequence of processes and managing the flow of the processes. Herein, a unit of the process managed by the workflow system is defined as a work, the business consisting of a sequence of works is defined as a business process, and each case of the sequence of works executed in accordance with the business process is defined as an instance.

Among the workflow systems of the type described above is the one disclosed in the U.S. application Ser. No. 09/377402 filed on Aug. 20, 1999.

In recent years, there is a demand for a system construction where existing business systems are interrelated to one another to achieve a sequence of business. For control over execution of the sequence of business, the workflow system is sometimes employed.

Among the above-mentioned workflow systems that use a plurality of different systems is the one disclosed in U.S. Pat. No. 6,026,365.

As the operation unique to the workflow system, restoration control over an instance being executed can be pointed out. The restoration control is a process where execution of a work being processed in a certain step is canceled, as in a change in the contents of a purchase order form, and a work in a previous step, of which processing has been completed, is executed again. When the workflow system performs control such as suspension control or restoration control over an instance being executed, execution of a work being processed is suspended or cancelled. At this point, there should be no inconsistency between the statuses of processes associated with the instance due to this suspension or cancellation of execution of the work. Accordingly, a special process is required for the restoration control in the work system including a plurality of systems.

### SUMMARY OF THE INNOVATION

An object of the present invention is to realize a workflow system that includes an external business system as a part of a workflow.

A further object of the present invention is to provide a workflow system that even manages the processing status of an external business system (or external system) and reports the status of the external business system to a user.

A still further object of the present invention is to provide a workflow system in which, by performing restoration control in accordance with the status of an external business system managed by the workflow system, any inconsistency between the statuses of an instance and business data is prevented.

A workflow system for causing an external business system to execute a part of works, according to the present invention, includes a unit for defining the external business system as one of the works, a unit for obtaining the status of the work being executed in the external business system, a unit for defining a process for suspending the work being executed in the external business system, and a unit for instructing the external business system to suspend the work being executed in the external business system. The unit for defining the process of suspension determines whether suspension can be performed, and defines the suspension process and a recovery process in accordance with the status of the work being executed in the external business system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a workflow system according to the present invention;

FIG. 2 is a diagram showing a structure of a business process definition table;

FIG. 3 is a diagram showing a structure of a work definition table;

FIG. 4 is a diagram showing a structure of an external system definition table;

FIG. 5 is a diagram showing a structure of an external system status definition table;

FIG. 6 is a diagram showing a structure of an instance status management table;

FIG. 7 is a flowchart showing a flow for defining a business process;

FIG. 8 is a flowchart showing a flow for starting an external business system;

FIG. 9 is a flowchart showing a flow for monitoring the external business system;

FIG. 10 is a flowchart showing a flow for obtaining the status of the external business system;

FIG. 11 is a flowchart showing processes when restoration of an instance has occurred;

FIG. 12 is an illustrative diagram showing a configuration of an inter-company system to which the present invention is applied;

FIG. 13 is an illustrative diagram showing examples of business process definitions used in the inter-company system; and

FIG. 14 is a diagram showing a structure of an external system status management table.

### DESCRIPTION OF THE EMBODIMENTS

1. System Configuration

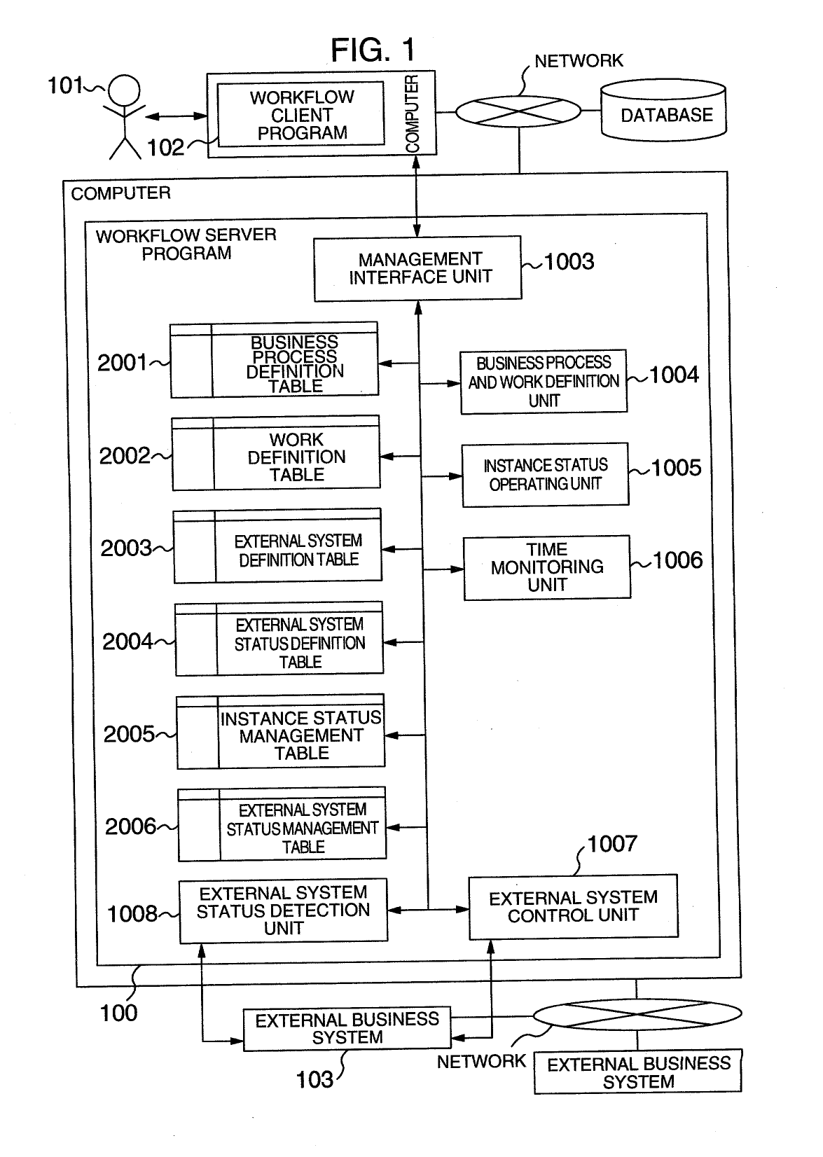

FIG. 1 shows a configuration of a workflow system according to the present invention. The workflow system comprises a workflow client program 102 whereby a user operates the workflow system, a workflow server program 100 that is the center of the workflow system, and external business systems (external systems) 103.

A server computer that contains the workflow server program 100 is connected to a client computer that contains the workflow client program 102 over a network.

The external business systems 103 are independent programs or systems, and may be contained in the server computer, or other computers connected to the server computer over the network.

The workflow server program will be abbreviated as a workflow server, while the workflow client program will be abbreviated as a workflow client.

The workflow server 100 includes a management interface unit 1003, a business process and work definition unit 1004, a business process definition table 2001, a work definition table 2002, an external system definition table 2003, an instance status operating unit 1005, an instance status management table 2005, a time monitoring unit 1006, an external system control unit 1007, an external system status detection unit 1008, an external system status definition table 2004, and an external system status management table 2006. The management interface unit 1003 performs communication with the workflow client 102. The business process and work definition unit 1004 defines business processes and works. The business process definition table 2001 stores the definitions of the business processes. The work definition table 2002 stores the definitions of the works. The external system definition table 2003 stores relationships between the works and the external business system, and the instance status operating unit 1005 effects a transition of the status of an instance. The instance status management table 2005 stores the statuses of instances, and the time monitoring unit 1006 manages a time. The external system control unit 1007 starts and controls an external business system in accordance with the definitions of a work and an associated business process. The external system status detection unit 1008 detects the status of an external business system, and the external system status definition table 2004 defines the possible statuses of the external business systems, and the external system status management table 2006 records the statuses of the external business systems detected by the external system status detection unit 1008.

Incidentally, a system manager prepares the business process definition table 2001, work definition table 2002, external system definition table 2003, and external system status definition table 2004 in advance.

Instance data required when an instance is processed according to the definition of an associated business process is stored on a recording medium that can be accessed by the workflow server. For example, the instance data may be stored in a database or other computer accessed by the workflow server.

When a processing status is managed for each instance, business process, associated works, an instance, IDs of users who process the instance, and the status of the instance may be associated with one another, for storage in a database. Alternatively, the instance status management table may be prepared and managed by the workflow server.

2. External Business Systems

As described before, the external business systems 103 are the independent programs or systems. The external business systems 103 may be general-purpose programs. For these programs and systems to be incorporated as a part of works for the workflow system, the external business system should have interface (I/F) functions to be described as follows:

(1) Start I/F: It is an I/F whereby the workflow server starts the program or system that is an external business system. Instance IDs and instance data are also transferred to the external business system via this I/F. The instance IDs and the instance data may be read from a predetermined area when starting the program or system.

(2) Suspension I/F: It is an I/F whereby the workflow server instructs an external business system to suspend execution of a work. The workflow server notifies the external business system of an instance ID and processing in the external business system resulting from suspension of execution of the work by means of commands and parameters.

(3) Inquiry I/F: It is an I/F whereby an external business system receives an inquiry from the workflow server and returns the status of a work of an instance to the workflow server.

(4) Completion I/F: It is an interface whereby an external business system notifies the workflow server of completion of processing of work of an instance upon completion of processing.

These interfaces use inter-task communication or network communication to receive commands and parameters from the workflow server, and send a response or notification to the workflow server using these communications.

These interfaces may be contained in the program or system that is an external business system, or may also be implemented as an interface program separate from the program or system.

The interface functions may also contain the function of converting instance IDs and parameters used by the workflow system into local IDs and parameters to be used in the program or system, and managing a one-to-one correspondence established between the instance IDs and the local IDs.

3. Tables

The structures of tables contained in the workflow server will be described.

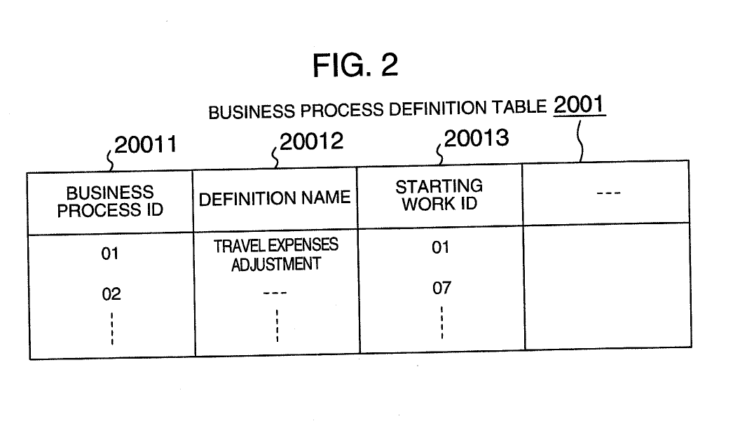

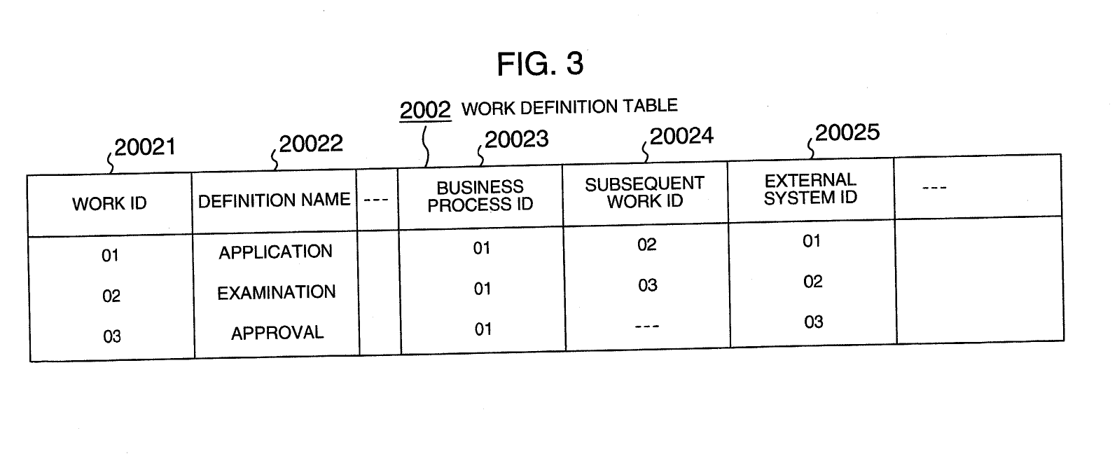

FIG. 2 shows the details of the business definition table 2001. Attribute information stored in the business process definition table 2001 includes business process definition IDs 20011, definition names 20012 indicating the names for identifying the business processes, and starting work IDs 20013 indicating the IDs of works to be processed first in the business process definitions. Respective works included in a business process will be defined in a table shown in FIG. 3.

FIG. 3 shows the details of the work definition table 2002. Attribute information stored in the work definition table 2002 includes work definition IDs 20021, work definition names 20022, business process IDs 20023 to which works belong, subsequent work IDs 20024 indicating IDs of subsequent works, and external system IDs 20025 associated with the works. The details of external system definitions will be shown next.

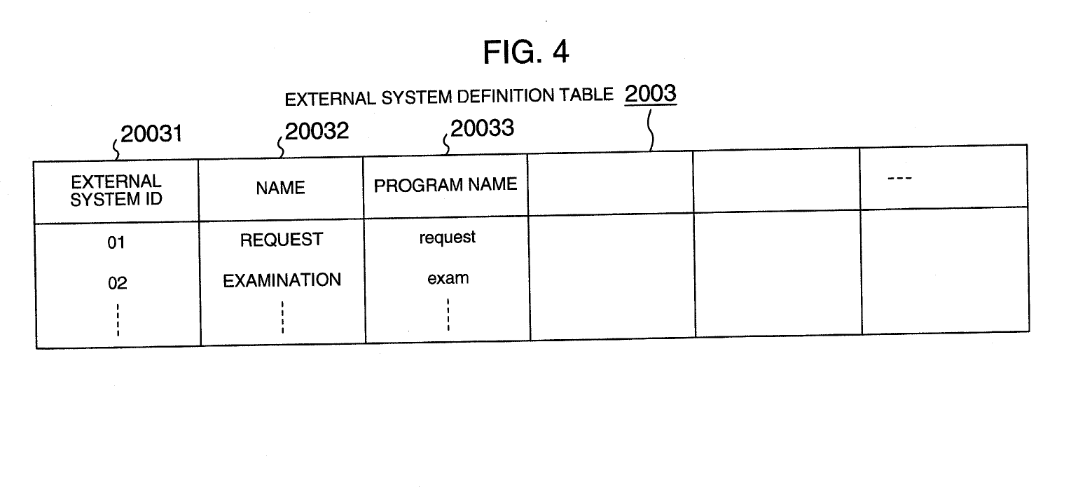

The external system definition table 2003, as the details of which are shown in FIG. 4, includes attribute information indicating external system IDs 20031, external system names 20032, and program start file names (program name) 20033 to store the definitions of the external business systems associated with the works managed by the workflow server.

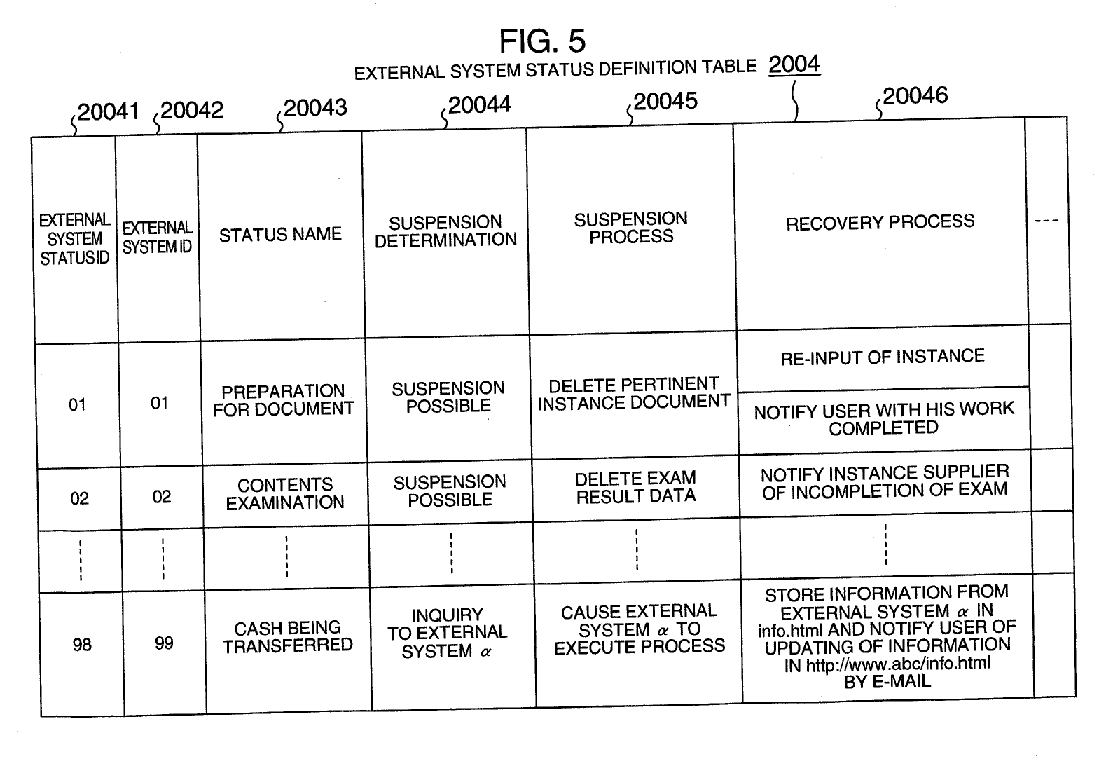

The external system status definition table 2004, as the details of which are shown in FIG. 5, includes attribute information indicating external system status IDs 20041, external system IDs 20042, status names 20043, a suspension determination field 20044 containing data for determining whether a pertinent process can be suspended or not when the workflow server has received a request for a restoration process, a suspension process field 20045 describing which process to be performed when suspension of the pertinent process is possible, and a recovery process field 20046 describing how to recover the pertinent process suspended after suspension of the pertinent process.

The suspension process field 20045 and the recovery process field 20046 are actually described in the form of commands and/or parameters to be transferred from the workflow server to an external business system via the suspension I/F.

The system manager may define data in the suspension determination field 20044, suspension process field 20045, and recovery process field 20046 in advance. They may also be modified whenever necessary according to other factors. Suppose the program in the workflow server monitors the CPU usage ratio of the workflow server, for example. Then, if the CPU usage ratio exceeds 70%, “suspension possible” may be entered into the “suspension determination” field, and “transfer process to computer B” may be entered into the “suspension process” field associated with the suspension determination. In this way, they may be modified according to the load of the workflow server.

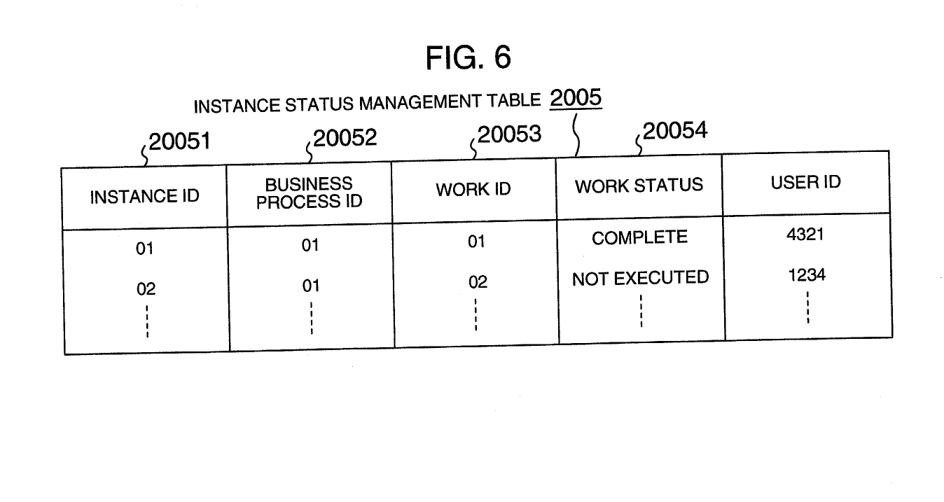

FIG. 6 shows the instance status management table 2005 used for managing the status of an instance. In this table, instance IDs 20051, business process IDs 20052, work IDs 20053, and work statuses 20054 are managed, being associated with one another. By using this table, the status of each instance can be traced.

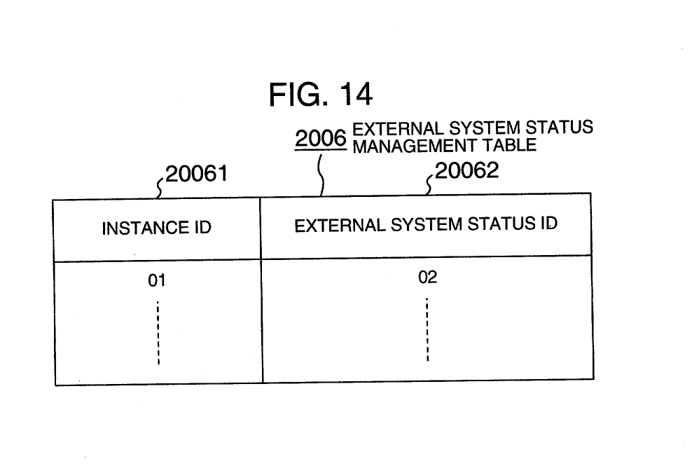

FIG. 14 shows the external system status management table 2006 used for managing the status of an instance in an external business system. Instance IDs 20061 are associated with external system status IDs 20062 for management. The external system status IDs 20062 are defined in the external system status definition table 2004.

4. Business Process Definition

A user or a system manager 101 of the workflow system uses the workflow client 102 to operate the workflow server 100. The workflow client 102 communicates with the management interface unit 1003 in the workflow server 100 to transmit a request from the user 101 to the workflow server 100. Since the workflow server performs processing according to a business process definition, the user 101 uses the business process and work definition unit 1004 to store the definition of a business process, the definitions of works that belong to the business process, external business system information associated with the definitions of the works in the business process definition table 2001, work definition table 2002, and external system definition table 2003, respectively.

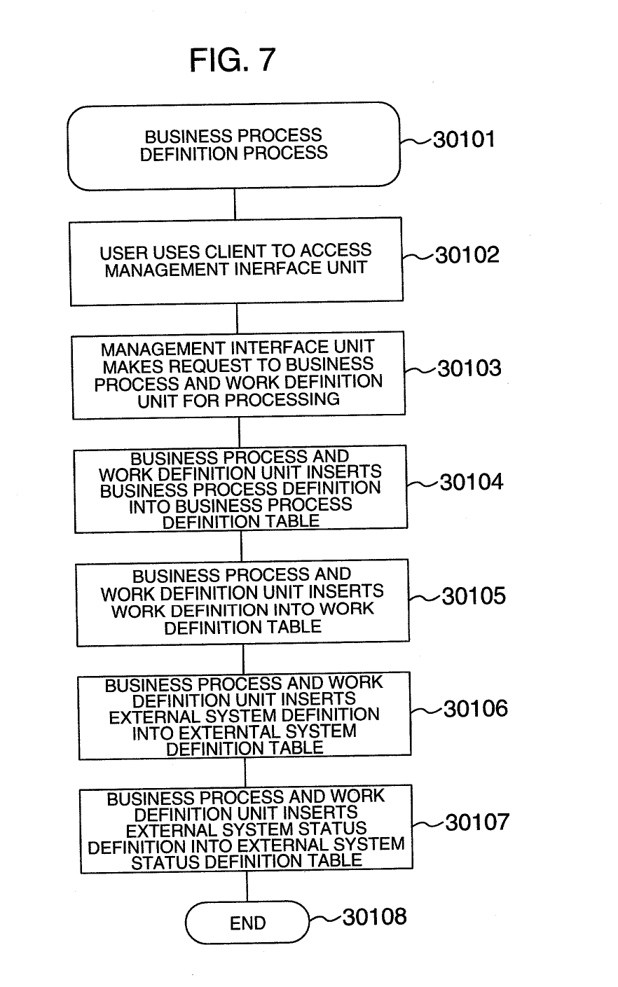

FIG. 7 is a flowchart showing a flow of a process for registering a business process definition with the workflow system. The user 101 uses the workflow client 102 to access the management interface unit 1003 in the workflow server 100 in steps 30101 to 30102. The management interface unit 1003 requests the business process and work definition unit 1004 to register the business process definition in step 30103.

In response to the operation of the user 101, the business process and work definition unit 1004 inserts the definition of a business process into the business process definition table 2001 in step 30104. Then, the business process and work definition unit 1004 inserts the definitions of works that belong to the business process into the work definition table 2002 in step 30105. The business process and work definition unit 1004 then inserts the external system definitions associated with the respective work definitions into the external system definition table 2003 in step 30106. Finally, the business process and work definition unit 1004 inserts the statuses of respective external systems into the external system status definition table 2004, in step 30107.

5. Business Process Execution

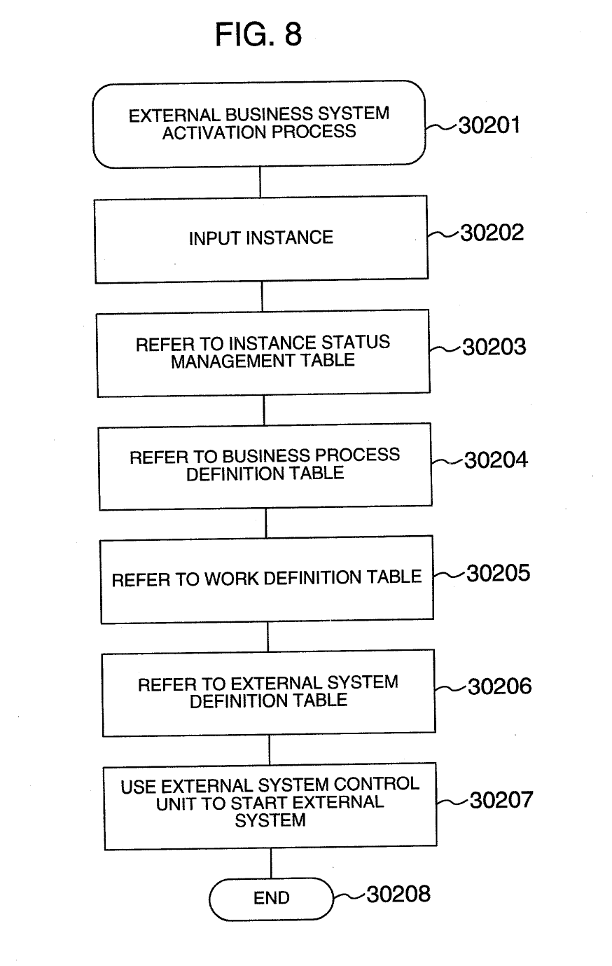

FIG. 8 is a flowchart showing a flow of a process for starting an external business system so as to execute the work defined in the business process. In step 30202, an instance is input to the workflow server. Herein, the instance input may mean the storing of the data associated with the instance, or the issue of a start request with data on the instance stored in advance. The instance is registered in the instance status management table 2005 with initial data. Then, the instance status operating unit 1005 checks the instance status management table 2005 to extract an instance ID 20051 of an instance for which no work has been started yet, or for which the status of the work is “not executed”, a business process ID 20052 of the instance, and a current work ID 20053 of the instance, in step 30203. The instance status operating unit 1005 refers to the business process definition table 2001 and the work definition table 2002 to obtain external system ID 20025 associated with the work of the extracted instance to be executed, in steps 30204 to 30205.

Thereafter, the instance status operating unit 1005 refers to the external system definition table 2003 to obtain operation for the external business system associated with the work, in step 30206. Then, the external system ID and the content of the operation associated with the external system ID is transmitted to the external system control unit 1007 to start the pertinent external business system 103 via the external business system start I/F, in steps 30207 to 30208.

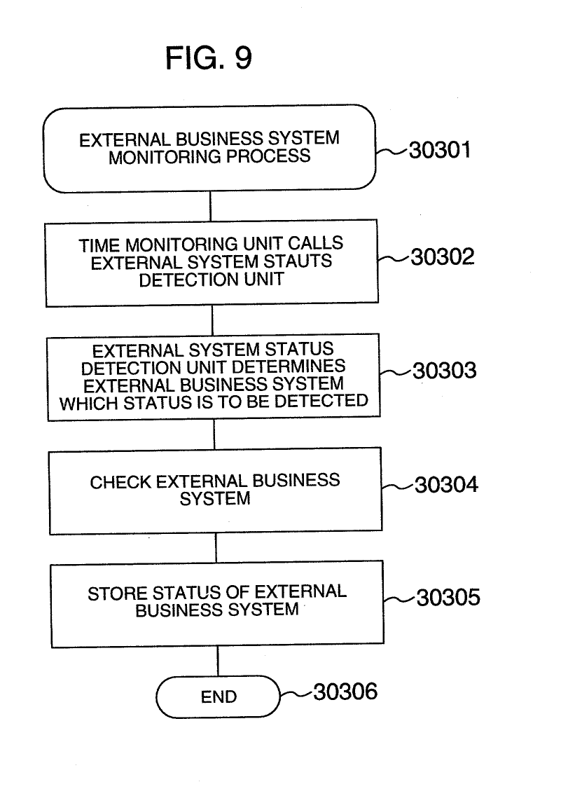

FIG. 9 is a flowchart showing a flow of a process for monitoring the status of an external business system. The time monitoring unit 1006 in the workflow server 100 periodically calls the external system status detection unit 1008 in steps 30301 to 30302. The external system status detection unit 1008 uses the instance status management table 2005, work definition table 2002, and external system definition table 2003 to determine the external business system to be monitored in step 30303. The external system status detection unit 1008 inquires of the determined external business system about the status of the work via the inquiry I/F.

Then, the external system status detection unit 1008 compares the status of the work transmitted from the external business system 103 with the status defined in the external system status definition table 2004, and then stores the result of comparison in the external system status management table 2006 in steps 30304 to 30306.

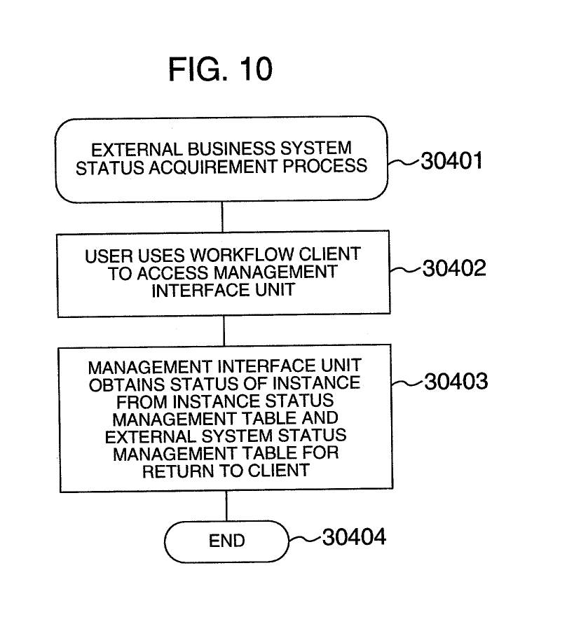

FIG. 10 is a flowchart showing a flow of a process whereby the system manager or user obtains the status of the work on an external business system. The user 101 uses the workflow client 102 to request the management interface unit 1003 in the workflow server 100 to obtain the status of the work on the external business system in steps 30401 to 30402.

Thereafter, the management interface unit 1003 accesses the instance status management table 2005 and the external system status management table 2006 to return the requested status of the work being processed by the external business system to the workflow client 102 in steps 30403 to 30404.

When a general user requests for the status of the work on an external business system, he or she should enter a user ID and an instance ID. When the system manager requests for the status of the work on an external business system, he or she enters a user ID and an instance ID, or he or she may indicate all instances or specify instances that satisfy a specific condition, instead of entering the instance ID.

In this instance status acquisition process, a description was directed only to the case where the status of the work on an external business system is obtained. The above-mentioned process may be included in the acquisition of the status for all works in a business process.

Further, an authorization for obtaining the status of the work may be limited. Alternatively, in order to prevent unauthorized access, the acquisition of the status of an work may be limited according to the user, or a user authentication process may be added.

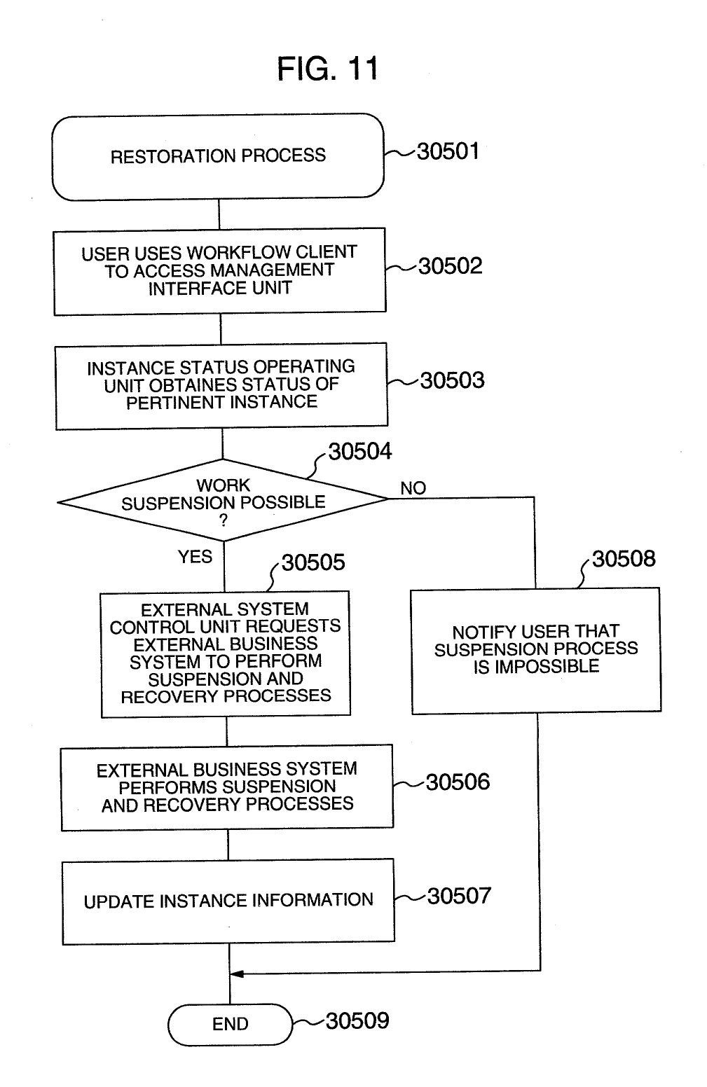

FIG. 11 is a flowchart showing a flow of a process when the user has made a request to the workflow server for restoration of an instance. The user 101 uses the workflow client 102 to make the request to the management interface unit 1003 in the workflow server 100 for restoration of the instance in steps 30501 to 30502. The management interface unit 1003 instructs the instance status operating unit 1005 to restore the instance. The instance status operating unit 1005 uses the instance status management table 2005, work definition table 2002, external system definition table 2003, and external system status management table 2006 to obtain the status of the instance being processed on an associated external business system, in step 30503.

Then, the obtained status is compared with the status in the suspension determination field 20044 in the external system status definition table 2004 to determine whether the process of restoration or suspension can be performed, in step 30504. If the work of the instance being processed can be suspended, the external system control unit 1007 requests the external business system 103 to execute the suspension process (both suspension and recovery processes, if necessary) via the suspension I/F according to the definition in the external system status definition table 2004, in steps 30505 to 30506.

If the external system status detection unit 1008 detects completion of the suspension process by the external business system 103, or if the external system status detection unit 1008 receives notification of completion of the suspension process from the external business system, the external system status detection unit 1008 updates the instance status management table 2005 and the external system status management table 2006 in step 30507. If the suspension is not possible, the instance status operating unit 1005 notifies the user that the restoration process is impossible, in step 30508.

6. Another Embodiment of Workflow System

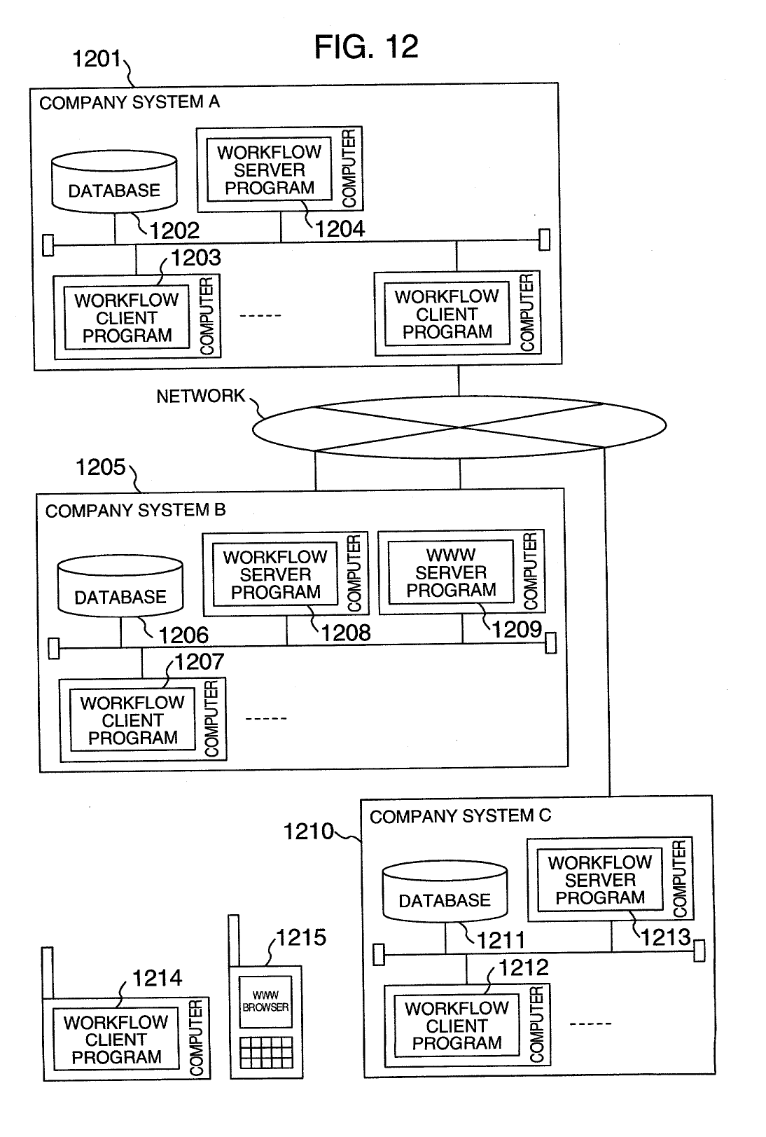

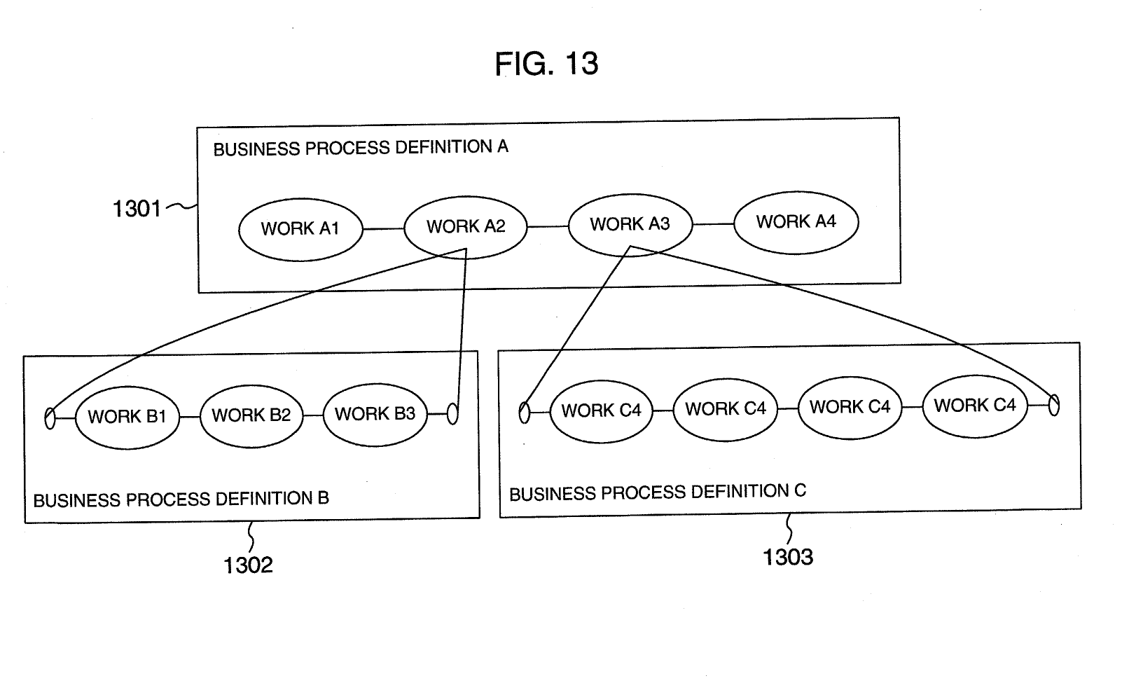

An application of the present invention to an inter-company system will be described with reference to FIGS. 12 and 13.

FIG. 12 shows a system in which a company system A 1201, a company system B 1205, and a company system C 1210 are networked together. The company systems A 1201, B 1205, and C 1210 include workflow servers 1204, 1208, and 1213, respectively, and software such as the workflow client, necessary for processing an instance.

FIG. 13 shows a business process executed by the inter-company system in FIG. 12.

A business process definition A 1301 is executed in the company system A. A business process definition B 1302 describes the contents of a work A2 in the business process definition A 1301, which is the work executed in the company system B 1205 that is an external business system as seen from the company system A 1201. A business process definition C 1303 describes the contents of a work A3 in the business process definition A 1301, which is the work executed in the company system C that is also an external business system as seen from the company system A 1201.

The workflow servers in the company systems A, B, and C manage definition tables associated with the business process definitions A, B, and C, respectively.

Suppose that the user input an instance, and then, a work A1 has already been processed and the work A2 is being executed. Then, when a restoration process is requested, processing is performed in accordance with the flow in FIG. 11 when restoration of the instance has been requested. Since the work A2 is executed in the company system B that is the external business system, the external system status detection unit in the company system A makes an inquiry to the workflow server in the company system B about the status of the pertinent work of the instance.

Upon receipt of the inquiry, the workflow server in the company system B refers to the instance status management table and the external system status definition table therein to check whether the pertinent work can be suspended or not. If the work can be suspended, the workflow server performs a suspension process or both the suspension process and a recovery process, if necessary, to update instance information in the company system B. Then, the workflow server in the company system B notifies the workflow server in the company system A of suspension. The workflow server in the company system B also notifies the contents of the suspension and restoration processes so as to clarify what kind of the suspension process has been executed in the company system B, in response to a request for suspension from the company system A. Different from the embodiment described before, the external business system determines whether the suspension is possible and also determines the contents the suspension and recovery processes.

If the pertinent work cannot be suspended, the company system B notifies the user and the workflow server in the company system A of it. Suppose that the work A2 is being executed, a work B1 in the business process definition B has already been executed, and a work B2 in the business process definition B is being executed, for example. If “suspension is possible” is in the “suspension determination” field, “delete instance data” is in the “suspension process” field, and “notify users who has executed and is executing works by E-mail” is entered in the “recovery process” field, with the work B2 being executed, the workflow server of the company system B notifies the user who has executed the work B1 and the user who is executing the work B2 of suspension of the work by E-mail. Further, the workflow server of the company system B notifies the company system A that the work has been suspended and that the recovery process is to “notify the users who has executed and is executing works by E-mail.” Incidentally, a mobile computer 1214 or a cellular phone 1215 may also perform notification of works described in these business process definitions and recovery and suspension processes.

Upon receipt of the notification, the workflow server of the company system A updates the statuses of the works therein, and notifies the user who has executed the work A1 and the user who is executing the work A2 of suspension of the work.

The work A2 and the work A3 are a collection of a plurality of works for the users of the company system B and the company system C, who execute the business process definition B and the business process definition C, respectively. However, the work A2 or the work A3 is a single work for the user of the company system A. Since the workflow servers in respective companies are interrelated to one another to perform the restoration process, the user of the company system A can keep track of the statuses of other company systems and do not have to perform suspension and recovery processes, thereby saving time and eliminating an inconvenience. Further, since suspension and recovery processes that have been defined in advance in accordance with respective works are executed in each of the systems, system managers' management works on execution statuses of the works can be reduced.

7. Modifications

The embodiments of the present invention described so far are just examples. The invention, however, is not limited to these embodiments. To take an example, in order to make a request to the workflow system for execution of processing, the user should use the workflow client. However, a specific program may be used for automatically generating the request.

The specific program may be a general client program. Alternatively, a dedicated program having an interface for requesting the workflow server to execute processing directly may be used.

Status monitoring of an external business system is performed upon the periodical call by the time monitoring unit. However, status monitoring may also be performed in response to a request from the workflow client. Alternatively, an external business system may also be configured to notify the workflow system server of a transition in the status of the external business system. Still alternatively, the external system status detection unit may directly access the status management table in the external business system to obtain necessary information.

Further, notification from the workflow system to the user may be performed by E-mail, a cellular phone, or a www service, in place of the workflow client. In this case, by preparing a table in which contact information of users such as the telephone numbers or the E-mail addresses of the users can be identified by the IDs of the users associated with respective works or the user who has input an instance, the notification by E-mail or the cellular phone becomes possible.

It should be further understood by those skilled in the art that the foregoing description has been made on embodiments of the invention and that various changes and modifications may be made in the invention without departing from the spirit of the invention and the scope of the appended claims.

What is claimed is:

1. A workflow system for causing an external business system to execute a part of works comprising:
means for defining the external business system as one of the works;
means for obtaining a status of the work being executed in the external business system;
means for defining a process for suspending the work being executed in the external business system; and
means for instructing the external business system to suspend the work being executed in the external business system.

2. The workflow system according to claim 1, wherein the means for defining the process of suspension defines whether suspension can be performed, the suspension process, and a recovery process in accordance with the status of the work being executed in the external business system.

3. The workflow system according to claim 1, wherein the means for obtaining the status of the work periodically inquires of the external business system about the status of the work being executed in the external business system.

4. The workflow system according to claim 1, further comprising:
means for displaying the status of the work being executed in the external business system in response to an inquiry from a user.

5. The workflow system according to claim 1, wherein the external business system is instructed to suspend the work in response to an instruction from a user.

6. The workflow system according to claim 1, wherein the external business system is instructed to suspend the work in response to a command from a specific program.

7. A business system that can be included in a part of a workflow, comprising:
means for receiving data on an instance in response to a command to start the system and then initiating a work associated with the instance; and
means for performing a commanded suspension process and then performing a commanded recovery process on the work associated with the instance, in response to a suspension command.

8. The business system according to claim 7, further comprising:
means for reporting a status of the work being executed, in response to an inquiry.

9. A method of controlling a workflow system for causing an external business system to execute a part of works, comprising the steps of:
defining a suspension process of the work being executed in the external business system in accordance with a status of the work being executed in the external business system;
obtaining the status of the work being executed in the external business system; and
instructing the external business system to execute the suspension process of the work being executed in the external business system in accordance with the status of the work.

10. The method of controlling the workflow system according to claim 9, wherein the external business system is instructed to suspend the work in response to an instruction from a user, and wherein when the work cannot be suspended, the user is notified that suspension of the work is impossible.

11. A program of controlling a workflow system for causing an external business system to execute a part of works, comprising codes for executing the steps of:
obtaining a status of the work being executed in the external business system; and
instructing the external business system to suspend the work according to a suspension process defined in advance in accordance with the status of the work being executed in the external business system.
